(19) United States
(12) Patent Application Publication
(10) Pub. No.: US 2015/0138184 A1
(43) Pub. Date: May 21, 2015

(54) Spatially interactive computing device

(71) Applicant: Apple Inc., Cupertino, CA (US)

(72) Inventors: Brett C. Bilbrey, Sunnyvale, CA (US); Ashley N. Saulsbury, Los Gatos, CA (US); David I. Simon, San Francisco, CA (US)

(73) Assignee: Apple Inc., Cupertino, CA (US)

(21) Appl. No.: 14/085,767

(22) Filed: Nov. 20, 2013

(51) Int. Cl. G06T 15/00; G06F 3/01

(52) U.S. Cl. CPC G06T 15/005; G06F 3/013
USPC 345/419

(57) ABSTRACT

A computing device may include a display with an overlay layer that enables presentation of 2D, 3D images, a simultaneous combination of 2D and 2D images, multiple view images, and/or combinations thereof. In some implementations, the overlay layer may be one or more LCD matrix pixel masks, a number of lenses, one or more LCD layers configurable as lenses, or various combinations thereof. In various implementations, the overlay layer may be adjusted to continue or alter display of 3D portions and/or multiple view portions when the orientation of the computing device is changed. In one or more implementations, the computing device may adjust the overlay layer based on movement and/or position of one or more users and/or one or more eyes of the user(s). In some implementations, the computing device may be capable of capturing one or more 3D images.

### TECHNICAL FIELD

This disclosure relates generally to computing devices, and more specifically to computing devices capable of displaying a spatially interactive, combined two-dimensional and three-dimensional display.

### BACKGROUND

Despite the availability of various forms of three-dimensional (3D) display technology, 3D displays are not particularly common. In many cases, the lowering of display resolution necessary to implement 3D or the requirement of 3D glasses in order to perceive the 3D may frustrate users to the point that the users prefer not to utilize 3D technology. In other cases 3D implementations may provide higher resolution 3D and/or enable 3D without 3D glasses, but may still not be very user-friendly due to inflexible and/or narrow ‘sweet spots’ (i.e., viewing perspective required in order for 3D to be seen), restriction of displayed 3D to a particular display orientation, ability to display in only 3D or only either in 3D or two-dimensional (2D), and other such issues. Common adoption of 3D displays may not occur without implementation of 3D display technology that is more user-friendly.

### SUMMARY

The present disclosure discloses systems and methods for displaying a combined 2D and 3D image. A computing device may include a display with an overlay layer that enables the display to present 2D, 3D images, a simultaneous combination of 2D and 2D images, multiple view images (i.e., different users see different images when looking at the same screen), and/or combinations thereof.

In some implementations, the overlay layer may be one or more liquid crystal display (LCD) matrix pixel masks, a number of lenses, one or more LCD layers configurable as lenses, or various combinations thereof.

In various implementations, the overlay layer may be adjusted to continue display (or alter display) of 3D portions and/or multiple view portions when the orientation of the computing device is changed.

In one or more implementations, the computing device may adjust the overlay layer based on movement and/or position of one or more users and/or one or more eyes of the user(s) in order to maintain the type of image being displayed (2D, 3D, combined 2D and 3D, multiple view, and so on). The computing device may determine and/or estimate such eye movement and/or position utilizing one or more image sensors, one or more motions sensors, and/or other components.

In some implementations, the computing device may be capable of capturing one or more 3D images, such as 3D still images, 3D video, and so on utilizing one or more image sensors. In such implementations, the computing device may utilize a variety of different 3D imaging techniques to capture 3D images utilizing the image sensor(s).

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a front plan view of a system for displaying a combined 2D and 3D image.

FIGS. 2A-2D illustrate a first example of a display screen that may be utilized in the computing device of FIG. 1.

FIGS. 3A-3C illustrate a second example of a display screen that may be utilized in the computing device of FIG. 1.

FIGS. 4A-4C illustrate a third example of a display screen that may be utilized in the computing device of FIG. 1.

FIGS. 5A-5C illustrate a fourth example of a display screen that may be utilized in the computing device of FIG. 1.

FIGS. 6A-6E illustrate example images that may be displayed by a system, such as the computing device of FIG. 1.

FIG. 7A is an isometric view of two users utilizing a computing device. The computing device may be the computing device of FIG. 1.

FIGS. 7B-7C illustrate example images that may be displayed by the computing device of FIG. 7A, which may be the computing device of FIG. 1.

FIG. 8 is a block diagram of a system including a computing device for displaying a combined 2D and 3D image. The computing device may be the computing device of FIG. 1.

FIG. 9 is a flow chart illustrating an example method for presenting 2D images, 3D images, combination 2D and 3D images, multiple view images, and/or combinations thereof. This method may be performed by the system of FIG. 1.

FIG. 10 is a flow chart illustrating an example method for determining a user's eye position. This method may be performed by the system of FIG. 1.

FIG. 11 is a flow chart illustrating an example method for capturing one or more 3D images. This method may be performed by the system of FIG. 1.

### DETAILED DESCRIPTION

The description that follows includes sample systems, methods, and computer program products that embody various elements of the present disclosure. However, it should be understood that the described disclosure may be practiced in a variety of forms in addition to those described herein.

The present disclosure discloses systems and methods for displaying a combined 2D and 3D image. A computing device may include a display with an overlay layer that enables the display to present 2D images, 3D images, a simultaneous combination of 2D and 3D images, multiple view images (i.e., different users see different images when looking at the same screen), and/or combinations thereof.

In some implementations, the overlay layer may be one or more liquid crystal display (LCD) matrix pixel masks, a number of lenses, one or more LCD layers configurable as lenses, or various combinations thereof.

In various implementations, the overlay layer may be adjusted to continue display (or alter display) of 3D portions and/or multiple view portions when the orientation of the computing device is changed.

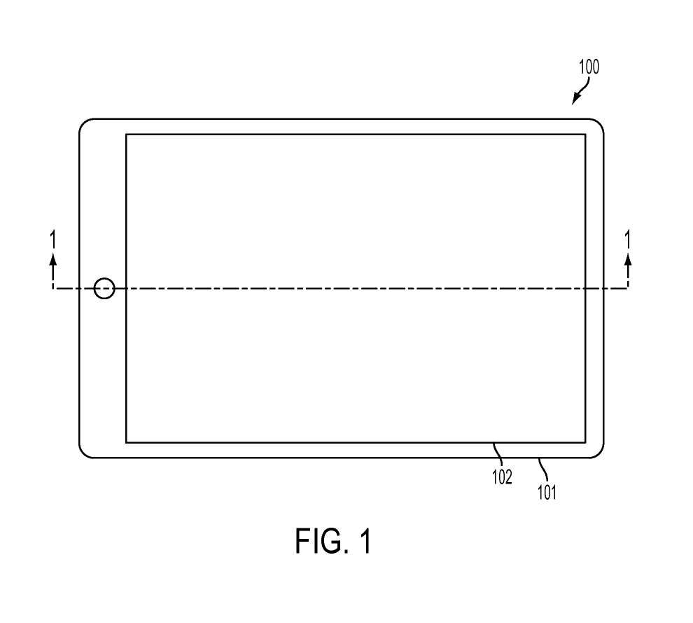

FIG. 1 is a front plan view of a system 100 for displaying a combined 2D and 3D image. The system 100 includes a computing device 101 with a display screen 102. Though the computing device is illustrated as tablet computing device, it is understood that this is for the purposes of example. In various implementations, the computing device may be any kind of computing device, such as a handheld computer, a mobile computer, a tablet computer, a desktop computer, a laptop computer, a personal digital assistant, a cellular telephone, a smart phone, and/or any other computing device.

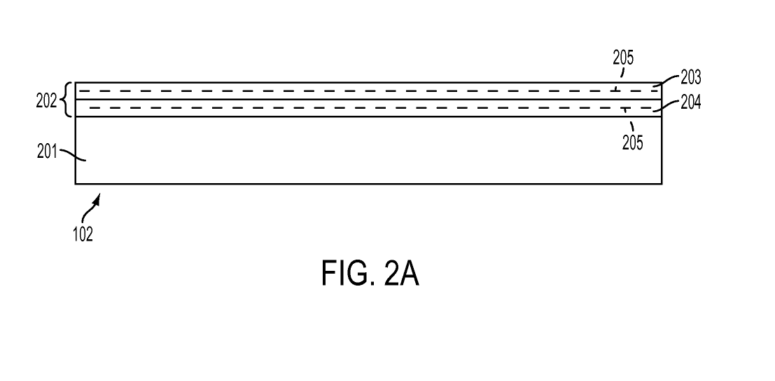

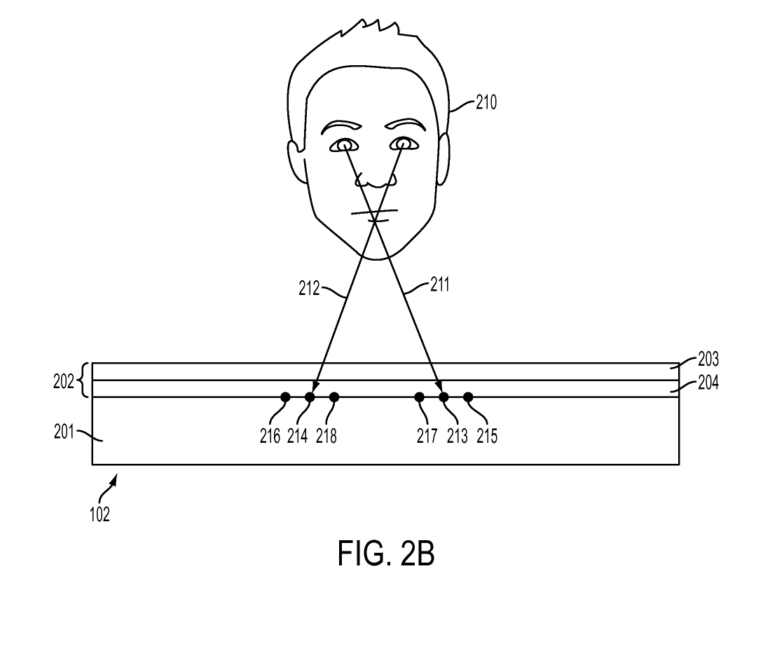

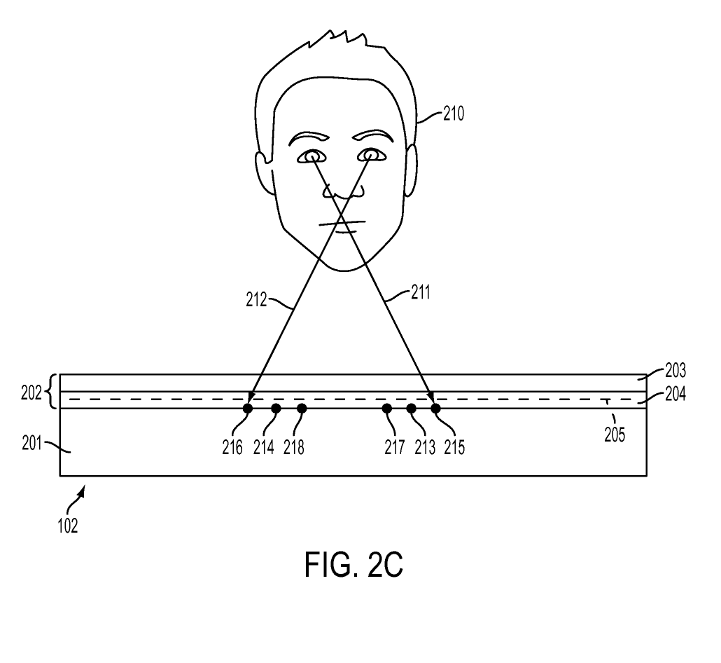

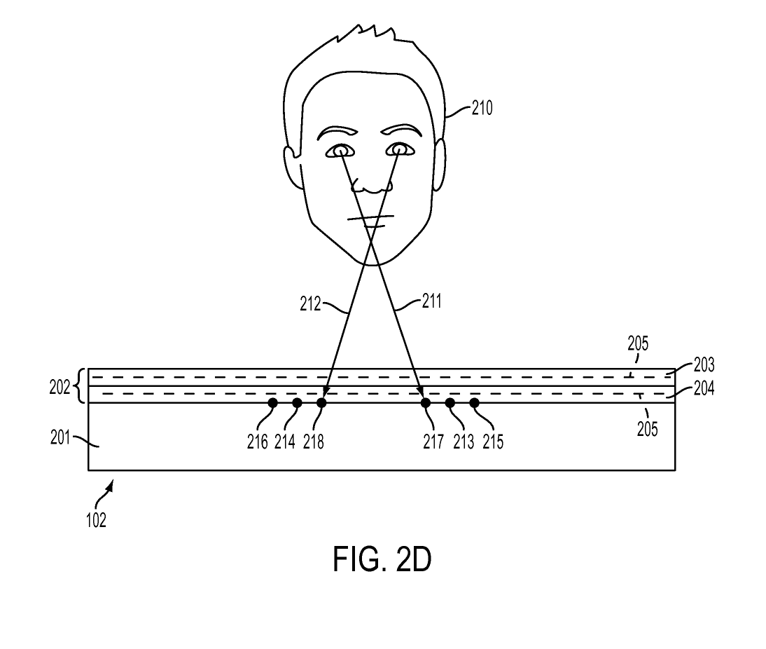

The display screen 102 may include one or more overlay layers (see FIGS. 2A-5C for examples) that enables the computing device 101 to utilize the display screen to present 2D images, 3D images, a simultaneous combination of 2D and 3D images, and/or multiple view images (i.e., different users see different images when looking at the same screen). The computing device may accomplish this by utilizing the overlay layer to control and/or adjust which portions of the display screen (such as pixels, pixel elements, and so on) are respectively presented to the right and/or left eyes of one or more respective users.

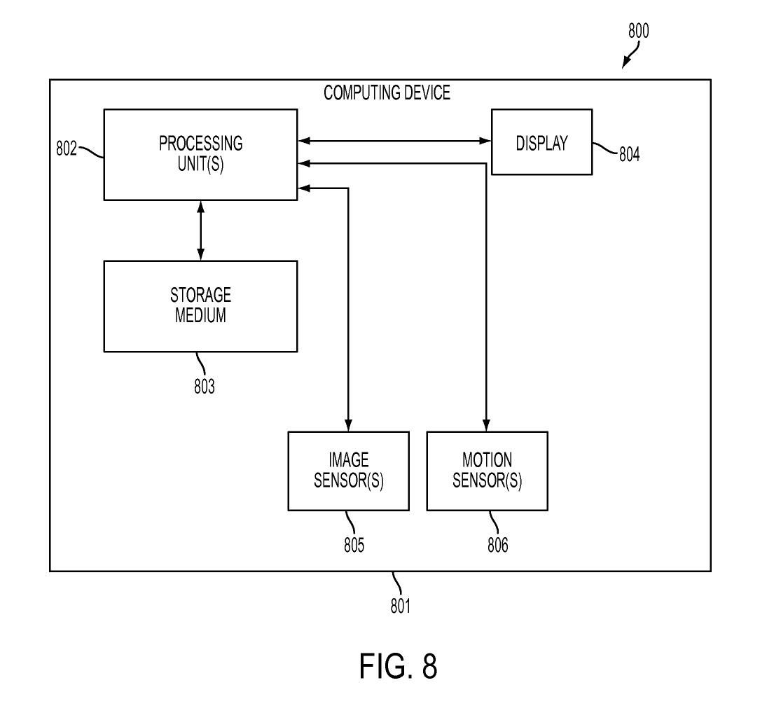

In one or more implementations, the computing device 101 may adjust the overlay layer based on movement and/or position of one or more users and/or one or more eyes of the user(s) in order to maintain the type of image being displayed (2D, 3D, combined 2D and 3D, multiple view, and so on). The computing device may determine and/or estimate such eye movement and/or position utilizing one or more image sensors (see FIG. 8), one or more motion sensors (such as one or more accelerometers, gyroscopes, and/or other such motion sensors), and/or other components.

In various implementations, the overlay layer may include one or more LCD matrix pixel masks, a number of lenses, one or more LCD layers configurable as lenses, various combinations thereof, and/or other such components. In various implementations, the overlay layer may be adjusted to continue display, or alter display, of 3D portions and/or multiple view portions when the orientation of the computing device 101 is changed.

In some implementations, the computing device 101 may be capable of capturing one or more 3D images, such as 3D still images, 3D video, and so on utilizing one or more image sensors (see FIG. 8) (such as one or more still image cameras, video cameras, and/or other kinds of image sensors). In such implementations, the computing device may utilize a variety of different 3D imaging techniques to capture 3D images utilizing the image sensor(s). For purposes of the disclosure herein, the term “image” is meant to include static images, video, graphics, text, and any other representation that may be shown on a display screen, whether static, moving, animated or the like.

FIG. 2A illustrates a first example of display screen 102 that may be utilized in the computing device 101 of FIG. 1. As illustrated, the display screen 102 includes a display layer 201 and one or more overlay layers 202. The display layer 201 may be any kind of display such as a LCD, a plasma display, a cathode ray tube display, an LED (light emitting diode) display, an OLED (organic light emitting diode) display, and/or other such display.

As illustrated, the overlay layer 202 includes a first layer 203 and a second layer 204. However, it is understood that this is an example. In various implementations the overlay layer 202 may include a single layer or may include more than two layers without departing from the scope of the present disclosure. (Although the path of the user's vision from each eye is shown as crossing one another in FIGS. 2A-2D, it should be appreciated that this is due to the use of single spatial points as representing the user's view. In actuality, the user would see a number of different points on the display simultaneously, and these points need not necessarily cause the user's visual field to cross in the fashion shown.)

The first layer 203 and the second layer 204 may each be LCD matrix mask layers. The LCD matrix mask layers may each include a matrix of liquid crystal elements 205 (which may be pixel sized elements, pixel element sized elements, squares, circles, and/or any other such shaped or sized elements). The liquid crystal elements may be activatable to block and deactivatable to reveal one or more portions of the display layer 201 (such as pixels, pixel elements, and so on) underneath. The activation and/or deactivation of the liquid crystal elements 205 in the first layer 203 and/or the second layer 204, the individual portions of the display layer 201 (such as pixels, pixel elements, and so on) that are visible to a particular eye of one or more users may be controlled, enabling 2D display, 3D display, combined 2D and 3D display, multiple view display, and so on.

FIG. 2B illustrates the display screen 102 where the liquid crystal elements 205 of the first layer 203 and the second layer 204 are not activated. As such, the path of vision of the left eye 212 of a user 210 sees a point 214 on the display layer 201 and the path of vision of the right eye 211 of the user 210 sees a point 213 on the display layer 201.

In FIG. 2C, the liquid crystal elements 205 of the second layer 204 are activated, blocking points 214 and 213. As such, the user's left eye 212 sees point 216 and the user's right eye sees point 215. In FIG. 2D, the liquid crystal elements 205 of the second layer 204 and the first layer 203 are activated, blocking points 214, 213, 216, and 215. As such, the user's left eye 212 sees point 218 and the user's right eye sees point 217. In this way, the LCD matrix mask layers may be utilized to control which portions (such as pixels, pixel elements, and so on) of the display layer 201 are visible to the respective eyes of one or more users.

In addition, multiple users 210 may be tracked by and view the system 100. As previously mentioned and explained in more detail below, the system 100 may determine and track the location of one or more users' eyes and/or gazes in order to accurately present 2D, 3D, or combination 2D/3D images to the users, as well as to update such images in response to motion of the user and/or the system 100. Thus, two users standing side by side or near one another may see the same points on the display, or the blocking/mask layers may activate to show each user a different image on the display, such as one image on the first layer 203 to the first user and one image on the second layer 204 to the second user. Further, both users may be shown 3D images, particularly if both are viewing the same image.

As yet another option, if both users wear polarized glasses or shutter glasses such as the type commonly used to display 3D images on current conventional 3D devices, each user could see a different 3D image on the display. The 3D glasses could operate with the display to generate a first 3D image on the first display layer 203, which may be seen by the first user but blocked from the second user's view by the mask layer (e.g., blocking points). The second user may view a 3D image generated on the second layer in cooperation with the second user's 3D glasses, while this second image is blocked from sight of the first user by the mask layer. Thus, each of the two display layers may be capable of either displaying polarized images to cooperate with appropriately polarized glasses, thereby generating a 3D image for a wearer/user, or may be capable of rapidly switching the displayed image to match the timing of shutters incorporated into the lenses of the glasses, thereby presenting to each eye of the wearer an at least slightly different image that cooperate to form a 3D image. The shutters in the glasses may be mechanical or electronic (such as a material that dims or becomes opaque when a voltage or current is applied thereto); the shutters may alternate being open and closed at different times, and generally offsetting times, such that one shutter is open while the other is closed.

Because each user may see a different image on the display of the system 100, it is possible to use such technologies to generate and display different 3D images to each user.

Although FIGS. 2A-2D illustrate all of the liquid crystal elements of one or more of the LCD matrix mask layers being activated and/or deactivated collectively, it is understood that this is for the purposes of example. In various implementations, the liquid crystal elements of a particular LCD matrix mask layer may be individually activated and/or deactivated. Activation and/or deactivation of a particular liquid crystal element may be accomplished by subjecting a portion of a particular LCD matrix mask layer to an electrical field. In some cases, this may be performed utilizing one or more traces (such as transparent conductive oxide traces), wires, and/or other such electrical connection media that are electrically coupleable to a power source (such as a battery, an AC (alternating current) power source, and/or other such power source) and/or the respective portion of the particular LCD matrix mask layer.

As the individual liquid crystal elements of a LCD matrix mask layer may be individually controllable, the displays provided by the display layer 201 and the overlay layer 202 may not be restricted to a particular orientation of the display layer 201 and the overlay layer 202. To the contrary, displays provided by the display layer 201 and the overlay layer 202 for a particular orientation of the display layer 201 and the overlay layer 202 may be changed when the orientation of the display layer 201 and the overlay layer 202 is changed (which may be detected utilizing one or more motion sensors, such as the motion sensors illustrated in FIG. 8) in order to continue and/or alter display of the display.

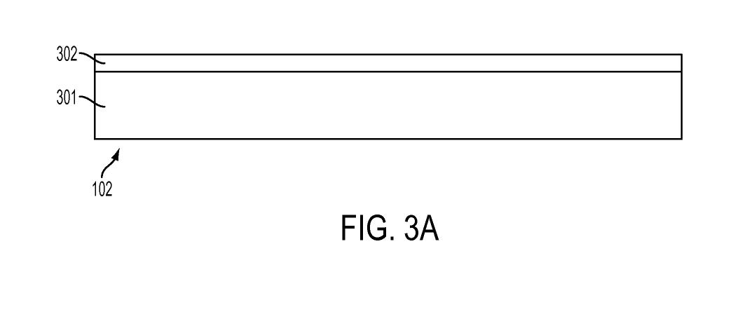

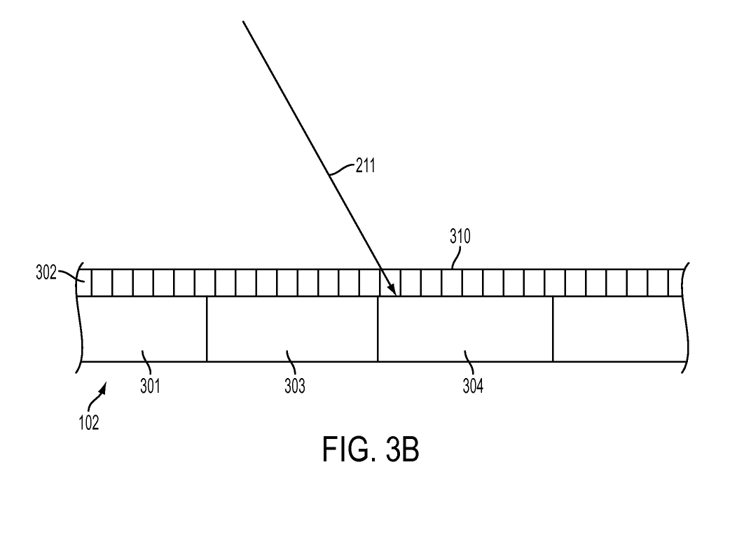

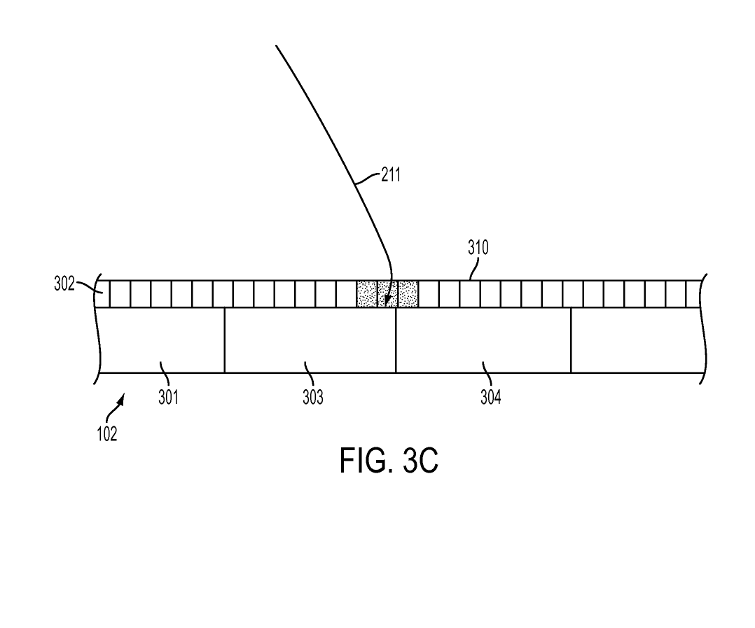

FIG. 3A illustrates a second example of display screen 102 that may be utilized in the computing device 101 of FIG. 1. As illustrated, the display screen 102 includes a display layer 301 and one or more overlay layers 302. The display layer 301 may be any kind of display such as a LCD, a plasma display, a cathode ray tube display, an LED (light emitting diode) display, an OLED (organic light emitting diode) display, and/or other such display.

The overlay layer 302 may be a LCD layer. As illustrated, the overlay layer 302 includes a single LCD layer. However, it is understood that this is an example. In various implementations the overlay layer 302 may include multiple LCD layers without departing from the scope of the present disclosure. The LCD layer may be operable to control the density of liquid crystals in a particular portion of the LCD layer by subjecting that portion to an electrical field of a particular strength. The density of liquid crystals in that portion may be increased by strengthening the electrical field to which the portion is subjected. Similarly, the density of liquid crystals in that portion may be decreased by weakening the electrical field to which the portion is subjected. In some cases, control of the electrical fields may be performed utilizing one or more traces (such as transparent conductive oxide traces), wires, and/or other such electrical connection media that are electrically coupleable to a power source and/or the respective portion of the LCD layer.

By controlling the density of liquid crystals in the LCD layer in a continuous gradient, the refractive index of that portion of the LCD layer may be controlled. This may control how light passes through the LCD layer, which may effectively turn the respective portion of the LCD layer into a lens and control which portions of the underlying display layer 301 are visible to right and/or left eyes of one or more users.

FIG. 3B shows a close-up view of a portion of the display screen 102 of FIG. 3A. As illustrated, the display layer 301 includes a first portion 303 and a second portion 304 (which may be pixels, pixel elements, and so on). Also as illustrated, the LCD layer of the overlay layer 302 includes a plurality of controllable liquid crystal regions 310.

In FIG. 3B, none of the controllable liquid crystal regions 310 are subjected to an electrical field and the path of vision of a user's eye 211 passes through the overlay layer 302 to the portion 304.

In FIG. 3C, a number of the controllable liquid crystal regions 310 are subjected to an electrical field, increasing the density of liquid crystals in that region. The continuous gradient of the increased density of the liquid crystals in that region changes the refractive index, bending the light that passes through the overlay layer 302 such that the path of vision of a user's eye 211 passes through the overlay layer 302 to the portion 303 instead of the portion 304. In this way, the LCD layer may be utilized to control which portions (such as pixels, pixel elements, and so on) of the display layer 301 are visible to the respective eyes of one or more users.

As the liquid crystal regions 310 may be individually controllable, the displays provided by the display layer 301 and the overlay layer 302 may not be restricted to a particular orientation of the display layer 301 and the overlay layer 302. To the contrary, displays provided by the display layer 301 and the overlay layer 302 for a particular orientation of the display layer 301 and the overlay layer 302 may be changed when the orientation of the display layer 301 and the overlay layer 302 is changed (which may be detected utilizing one or more motion sensors, such as the motion sensors illustrated in FIG. 8) in order to continue and/or alter display of the display.

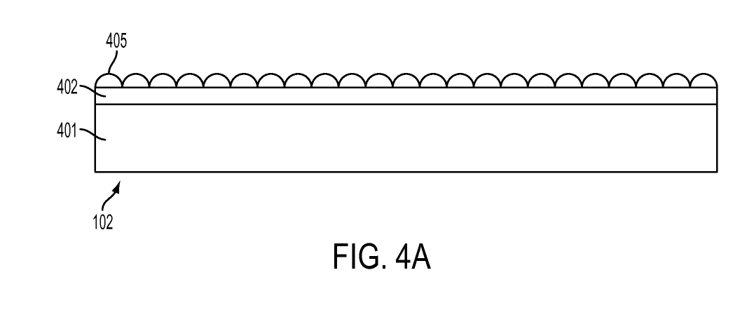

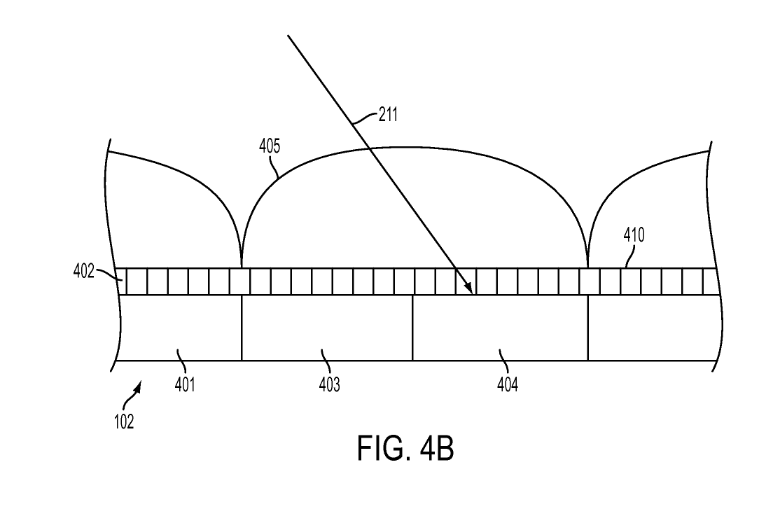

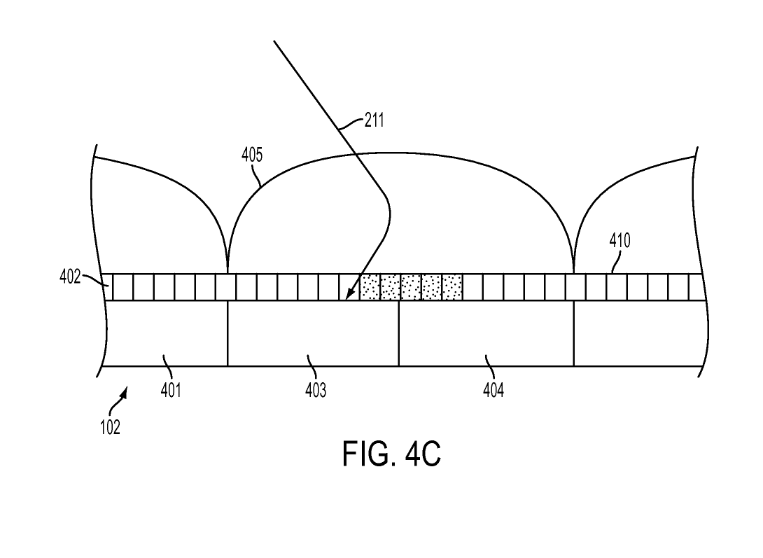

FIG. 4A illustrates a third example of display screen 102 that may be utilized in the computing device 101 of FIG. 1. As illustrated, the display screen 102 includes a display layer 401 and an overlay layer including one or more LCD layers 402 and a plurality of circular lenses 405. The display layer 401 may be any kind of display such as a LCD, a plasma display, a cathode ray tube display, an LED (light emitting diode) display, an OLED (organic light emitting diode) display, and/or other such display.

The circular lenses 405 may direct light passing through the circular lenses 405. The LCD layer 402 positioned below the circular lenses 405 may be operable to control the density of liquid crystals in a particular portion of the LCD layer by subjecting that portion to an electrical field of a particular strength. The density of liquid crystals in that portion may be increased by strengthening the electrical field to which the portion is subjected. Similarly, the density of liquid crystals in that portion may be decreased by weakening the electrical field to which the portion is subjected. In some cases, control of the electrical fields may be performed utilizing one or more traces (such as transparent conductive oxide traces), wires, and/or other such electrical connection media that are electrically coupleable to a power source and/or the respective portion of the LCD layer.

By controlling the density of liquid crystals in the LCD layer in a continuous gradient, the refractive index of that portion of the LCD layer may be controlled. This may control how light passes through the circular lenses 405 and the LCD layer, effectively altering the optical properties of the circular lenses 405. This may control which portions of the underlying display layer 401 are visible to right and/or left eyes of one or more users.

FIG. 4B shows a close-up view of a portion of the display screen 102 of FIG. 4A. As illustrated, the display layer 401 includes a first portion 403 and a second portion 404 (which may be pixels, pixel elements, and so on). Also as illustrated, the LCD layer 402 includes a plurality of controllable liquid crystal regions 410.

In FIG. 4B, none of the controllable liquid crystal regions 410 are subjected to an electrical field and the path of vision of a user's eye 211 is directed by one of the circular lenses 405 through the LCD layer 402 to the portion 404.

In FIG. 4C, a number of the controllable liquid crystal regions 410 are subjected to an electrical field, increasing the density of liquid crystals in that region. The continuous gradient of the increased density of the liquid crystals in that region changes the refractive index of that portion and the respective circular lens 405, bending the light that passes through the respective circular lens 405 and the overlay layer 402 such that the path of vision of a user's eye 211 passes through the respective circular lens 405 and the overlay layer 402 to the portion 403 instead of the portion 404. In this way, the circular lenses 405 and the LCD layer may be utilized to control which portions (such as pixels, pixel elements, and so on) of the display layer 401 are visible to the respective eyes of one or more users.

As the individual liquid crystal regions 410 may be individually controllable, the displays provided by the display layer 401, the overlay layer 402, and the circular lenses 405 may not be restricted to a particular orientation of the display layer 401, the overlay layer 402, and the circular lenses 405. To the contrary, displays provided by the display layer 401, the overlay layer 402, and the circular lenses 405 for a particular orientation of the display layer 401, the overlay layer 402, and the circular lenses 405 may be changed when the orientation of the display layer 401, the overlay layer 402, and the circular lenses 405 is changed (which may be detected utilizing one or more motion sensors, such as the motion sensors illustrated in FIG. 8) in order to continue and/or alter display of the display.

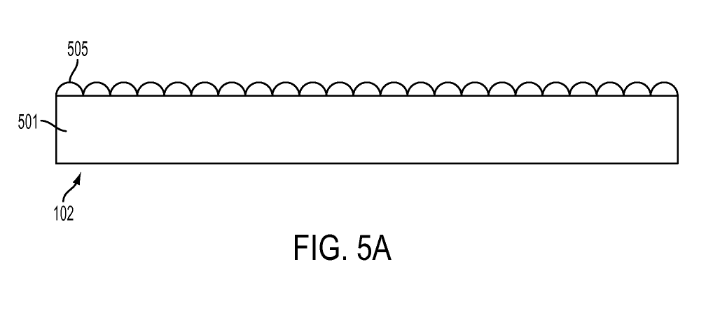

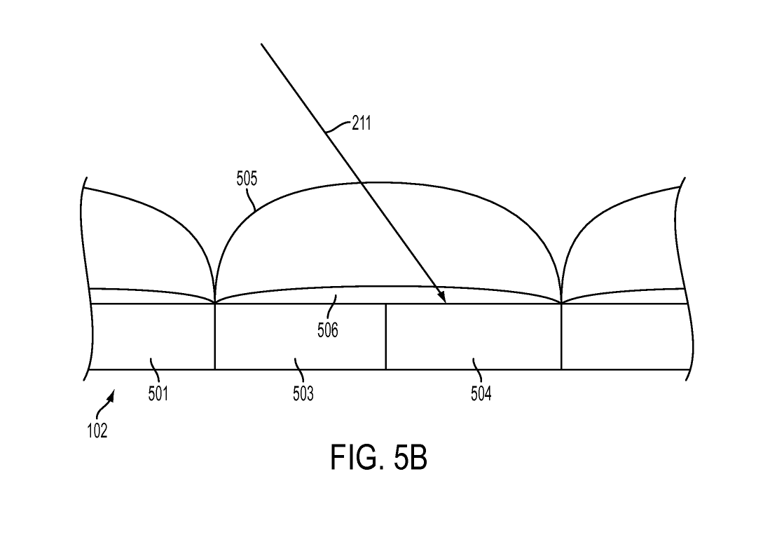

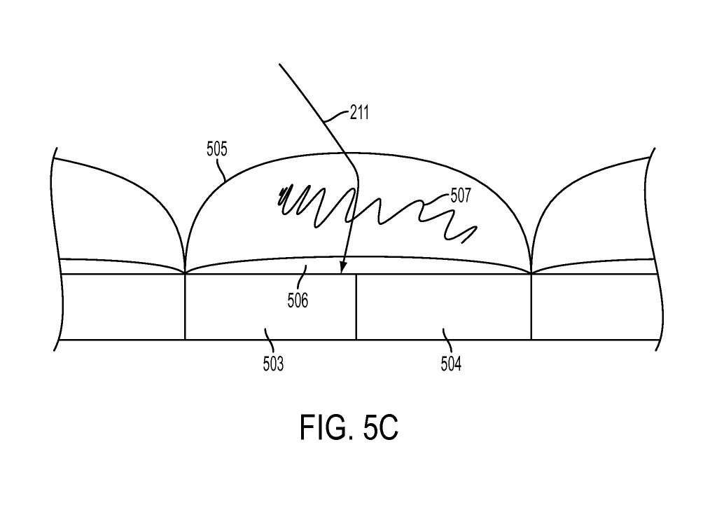

FIG. 5A illustrates a fourth example of display screen 102 that may be utilized in the computing device 101 of FIG. 1. As illustrated, the display screen 102 includes a display layer 501 and circular lenses layer 505. The display layer 501 may be any kind of display such as a LCD, a plasma display, a cathode ray tube display, an LED (light emitting diode) display, an OLED (organic light emitting diode) display, and/or other such display.

The circular lenses 505 may direct light passing through the circular lenses 505. The circular lenses 505 may be LCD lenses and may be operable to control the density of liquid crystals in a particular portion of particular circular lenses by subjecting that portion to an electrical field of a particular strength. The density of liquid crystals in that portion may be increased by strengthening the electrical field to which the portion is subjected. Similarly, the density of liquid crystals in that portion may be decreased by weakening the electrical field to which the portion is subjected. In some cases, control of the electrical fields may be performed utilizing a curved transparent oxide electrode configured on the underside of each of the circular lenses 505. In other cases, control of the electrical fields may be performed utilizing one or more traces (such as transparent conductive oxide traces), wires, and/or other such electrical connection media that are electrically coupleable to a power source and/or the respective circular lens 505.

By controlling the density of liquid crystals in respective circular lenses 505 in a continuous gradient, the refractive index of that circular lens 505 may be controlled. This may control how light passes through the circular lenses 505, effectively altering the optical properties of the circular lenses 505. This may control which portions of the underlying display layer 501 are visible to right and/or left eyes of one or more users.

FIG. 5B shows a close-up view of a portion of the display screen 102 of FIG. 5A. As illustrated, the display layer 501 includes a first portion 503 and a second portion 504 (which may be pixels, pixel elements, and so on). Also as illustrated, a circular electrode 506 is configured beneath one of the circular lenses 505.

In FIG. 5B, the circular lens 505 is not subjected to an electrical field and the path of vision of a user's eye 211 is directed by the circular lens 505 to the portion 504.

In FIG. 5C, the circular lens 505 is subjected to an electrical field utilizing curved electrode 506, increasing the density of liquid crystals 507 in a portion of the circular lens 505. The continuous gradient of the increased density of the liquid crystals 507 in that portion of the circular lens 505 changes the refractive index of the circular lens 505, bending the light that passes through the circular lens 505 such that the path of vision of a user's eye 211 passes through the circular lens 505 to the portion 503 instead of the portion 504. In this way, the circular lenses 505 may be utilized to control which portions (such as pixels, pixel elements, and so on) of the display layer 501 are visible to the respective eyes of one or more users.

As the circular lenses of the circular lenses layer 505 may be individually controllable, the displays provided by the display layer 501 and the circular lenses layer 505 may not be restricted to a particular orientation of the display layer 501 and the circular lenses layer 505. To the contrary, displays provided by the display layer 501 and the circular lenses layer 505 for a particular orientation of the display layer 501 and the circular lenses layer 505 may be changed when the orientation of the display layer 501 and the circular lenses layer 505 is changed (which may be detected utilizing one or more motion sensors, such as the motion sensors illustrated in FIG. 8) in order to continue and/or alter display of the display.

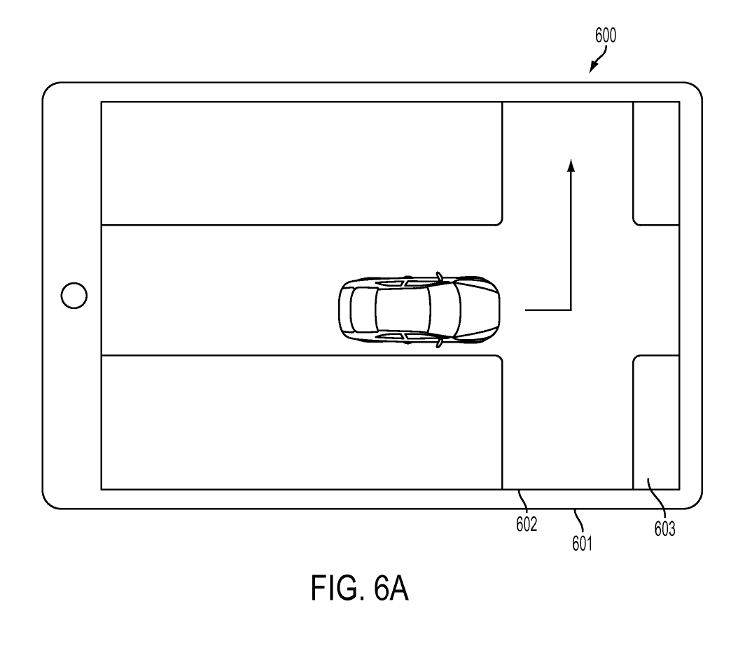

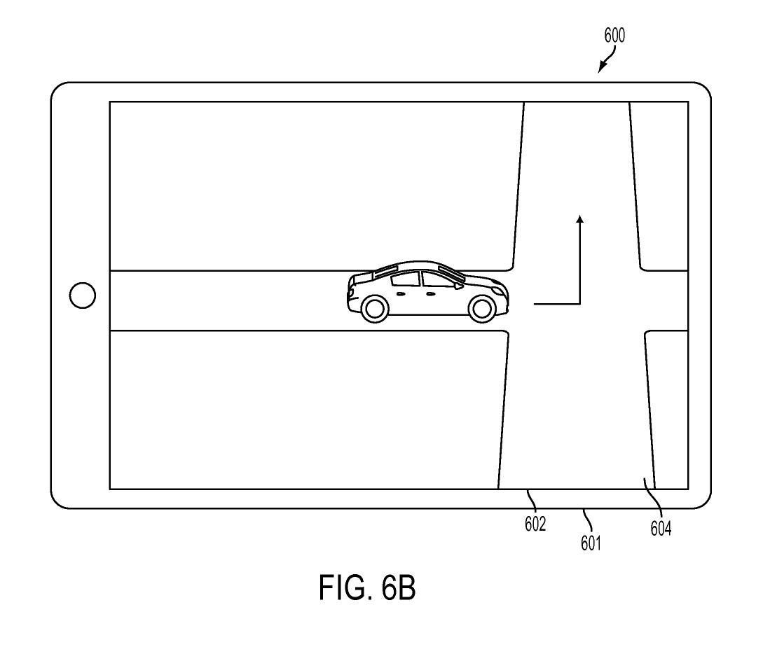

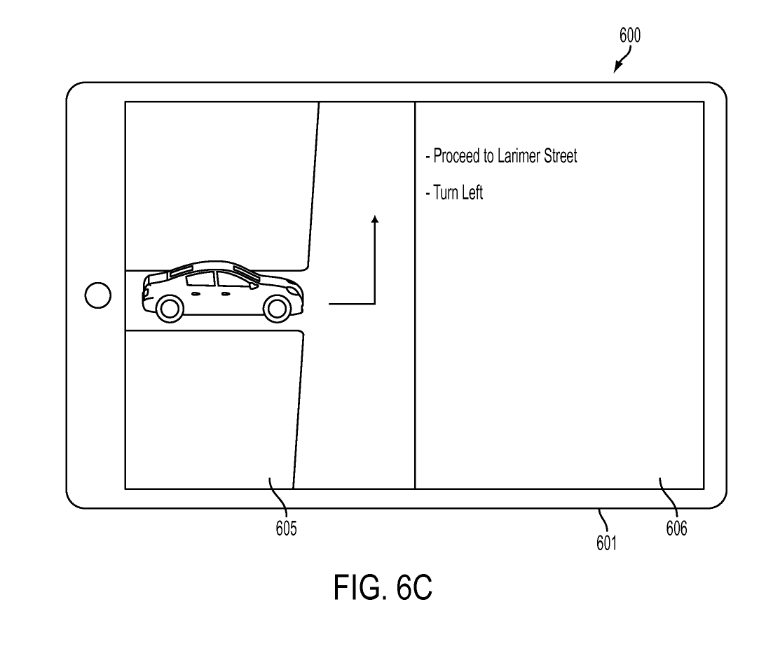

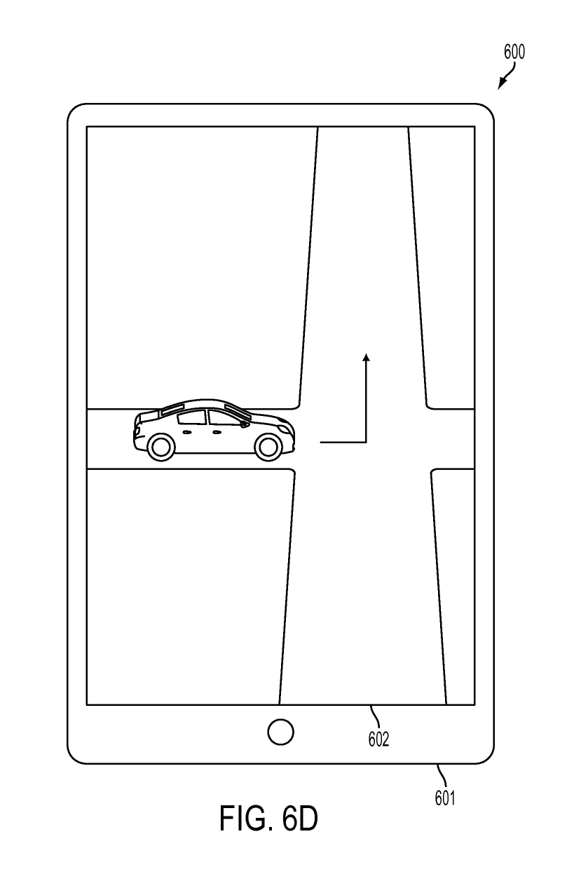

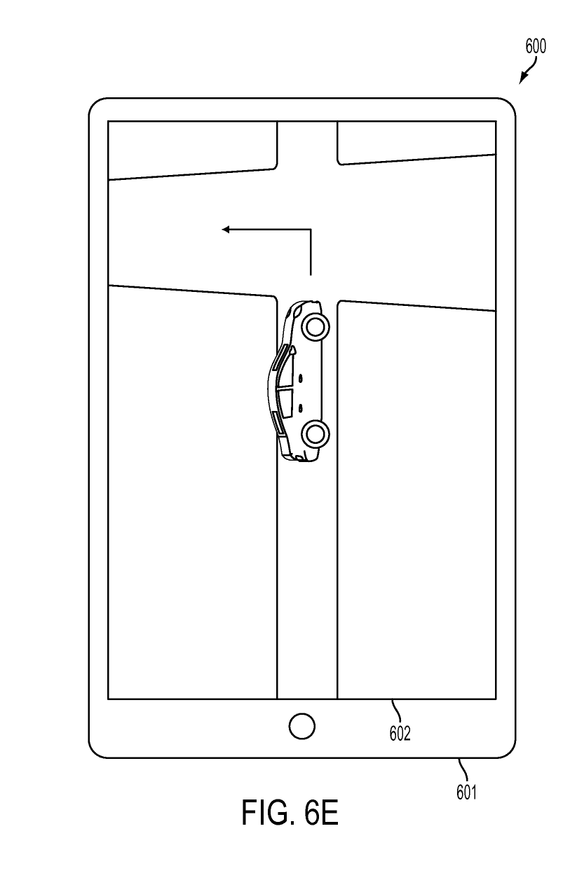

FIGS. 6A-6E illustrate sample images displayed by a system 600. The system 600 may include a computing device 601, which may be the computing device 101 of FIG. 1. The computing device may be capable of displaying 3D images, 2D images, or a combination of both. The determination whether a particular image is shown in 2D or 3D may be controlled by user preferences, an application, environmental factors and the like. FIGS. 6A-6E show one non-limiting example of an application that can switch between 2D and 3D data display, as well as a simultaneous display of 2D and 3D images in different regions of the screen. Such methods, techniques and capabilities are described with respect to a particular application but can be employed for the display of any suitable image or images.

As illustrated in FIG. 6A, the sample computing device 601 displays a top-down 3D image 603 displayed by a sample application, such as an automotive navigation program on a display screen 602. FIG. 6B illustrates the computing device 601 switching perspectives to display the same automotive navigation presentation as a perspective 3D image 604. This perspective shift may occur as the user tilts the device or reorients himself with respect to the device, for example, or inputs a gestural command or touch command. Examples of gestural commands are set forth in more detail later herein.

It should be appreciated that either or both of the images shown in FIGS. 6A-6B may be two-dimensional displays, as well, or one image could be two-dimensional and one three-dimensional.

However, the computing device 601 may not only be capable of either a 2D display mode or a 3D display mode. FIG. 6C illustrates the computing device 601 in a combined 2D and 3D mode where a first portion of the image 605 is a 3D portion and a second portion of the image 606 is a 2D portion. As illustrated, the 3D portion 605 illustrates a 3D visual representation of how to navigate an automobile to a user's destination. As further illustrated, the 2D portion 606 illustrates text directions specifying how the user can navigate to the user's destination. This may be useful when text and other images are combined, such as video or graphics. A user may desire text to be shown in a 2D view while appreciating or desiring the enhanced qualities and abilities of a 3D view for graphics or video.

Further, the computing device 601 may not only be capable of a 2D mode, a 3D mode, a multiple view mode, and/or a combined 2D and 3D mode. To the contrary, in some implementations, the computing device 601 may be capable of switching back and forth between several of these modes while presenting the same and/or different images.

The computing device 601 may be operable to adjust display in response to changes in computing device 601 orientation (which may be detected utilizing one or more motion sensors, such as the motion sensors illustrated in FIG. 8) in order to continue display, or alter display, of 3D portions and/or multiple view portions when the orientation of the computing device 601 is changed. This may be possible because individual portions of an overlay of a display screen of the computing device 601 are individually controllable, thus enabling 2D displays, 3D displays, combined 2D and 3D displays, multiple view displays, and so on regardless of the orientation of the computing device 601.

For example, when the computing device 601 is displaying a 2D image like in FIG. 6A and the computing device 601 is rotated 90 degrees, the 2D image may be rotated 90 degrees so that it appears the same or similar to a user. By way of another example, when the computing device 601 is displaying a multiple view display (such as two different versions of the same screen display that are presented to two different users based on their different viewing perspectives) and the computing device is rotated 90 degrees, the multiple view display may be rotated such that the multiple viewers are still able to view their respective separate views of the display. Generally, the foregoing may apply upon and rotation or repositioning of the device 601 at any angle or around any axis. Since the device may track a user's eyes and know its own orientation, 3D imagery may be adjusted and supported such that any angular orientation may be accommodated and/or compensated for.

By way of a third example, when the computing device 601 is displaying a 3D image like in FIG. 6B and the computing device 601 is rotated 90 degrees, the 3D image may be kept in the same orientation so that it appears the same or similar to a user. This is illustrated by FIG. 6D.

By way of a fourth example, when the computing device 601 is displaying a 3D image like in FIG. 6B and the computing device 601 is rotated degrees, the 3D image may be altered such that a different view of the 3D image is viewable by the user. Such rotation of the 3D image of FIG. 6B to present a different view of the 3D image to a user is illustrated by FIG. 6E. As illustrated, the computing device 601 has been rotated 90 degrees and the 3D image is still viewable in 3D, but presents a 90 degree rotated view of the 3D image that corresponds to what would have been visible to the user had an actual 3D object been rotated in a similar fashion.

Additionally, though various examples of possible display behaviors have been presented with regarding to continuing to display and/or altering display of 2D displays, 3D displays, combined 2D and 3D displays, and/or multiple view displays, it is understood that these are provided as examples. In various implementations, various other display behaviors could be performed without departing from the scope of the present disclosure.

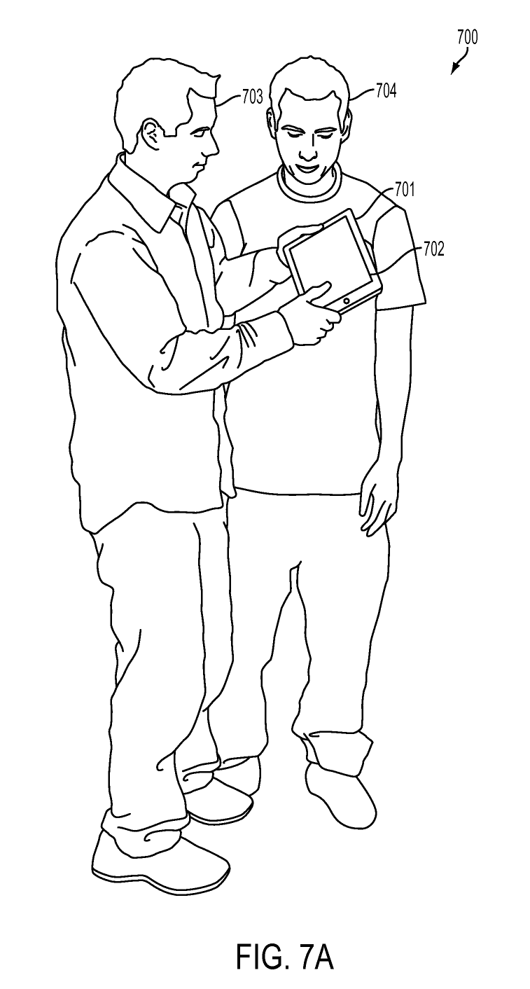

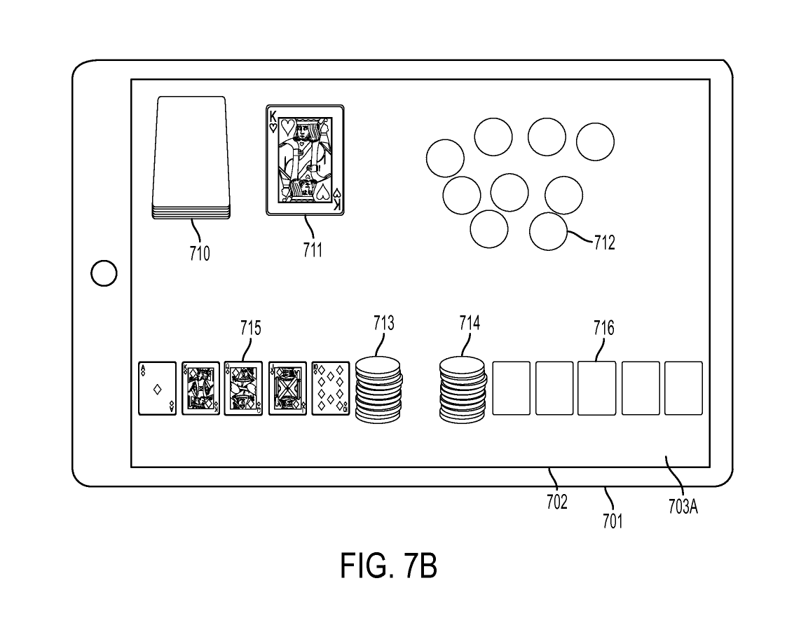

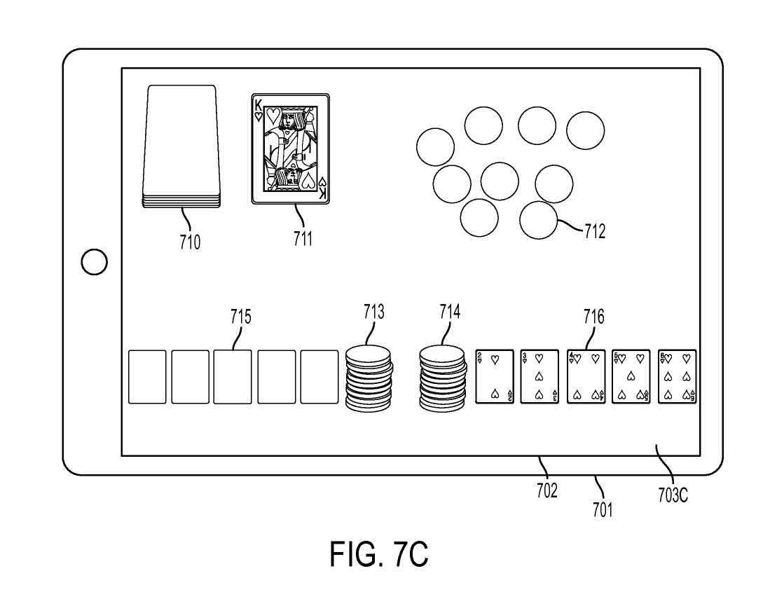

FIG. 7A illustrates a system 700 that includes a computing device 701, which may be the computing device 101 of FIG. 1. As illustrated in FIG. 7A, a first user 703 and a second user 704 are both able to view a display screen 702 of the computing device 701. Although both the first user 703 and the second user 704 are both able to view the display screen 702, the computing device 701 may be able to operate in a multiple view mode (or dual view mode, since there are two users) based on the respective viewing perspectives of the first user 703 and the second user 704. Such a multiple view may provide a different version of the display screen to each user, the same version of the display screen to both users, or provide respective versions to the respective users that include some common portions and some individual portions. One example of a multiple view application is given with respect to FIGS. 7B-7C, but it should be understood that the principles may apply to any application, operation, software, hardware, routine or the like.

FIG. 7B illustrates the computing device 701 presenting a display 703A to the first user 703 of video poker game being played by the first user 703 and the second user 704. As illustrated, the video poker game includes a card deck 710, a discard pile 711, a bet pile of chips 712, a set of cards 715 for the first user 703, chips 713 for the first user 703, a set of cards 716 for the second user 704, and a set of chips 714 for the second user 704. As this is provided to the first user 703, the first user's 703 set of cards 715 are shown whereas the second user's 704 set of cards 716 are obscured.

FIG. 7C illustrates the display 703C provided to the second user 704 of the same video poker game. As illustrated, the card deck 710, the discard pile 711, the bet pile of chips 712, the set of cards 715 for the first user 703, the chips 713 for the first user 703, the set of cards 716 for the second user 704, and the set of chips 714 for the second user 704 are also displayed in the display 703C provided to the second user 704. However, as also illustrated, the second user's 704 set of cards 716 are shown whereas the first user's 703 set of cards 715 are obscured. In this way, both users may utilize the same device to play the game while still being provided with information that is only viewable by a respective user. As with previous examples, the specifics of the example (e.g., the images shown) may vary between embodiments and may be application-dependent, user-dependent, vary with environment (such as lighting), relative positioning of the user or users with respect to the device and/or each other, and so on. Thus, the foregoing is meant as a non-limiting example only.

It should be appreciated that, in some embodiments, a three-dimensional display may be either spatially variant or spatially invariant with respect to a user's position and/or motion. Continuing with the example, above, the three-dimensional aspects of the game may vary or change as a user moves with respect to the computing device (or vice versa). The may enable a user to look around the three-dimensional display and see different angles, aspects, or portions of the display as if the user were walking around or moving with respect to a physical object or display (e.g., as if the three-dimensionally rendered image were physically present).

The image being displayed by the system may be updated, refreshed, or otherwise changes to simulate or create this effect by tracking the relative position of a user with respect to the system, as detailed elsewhere herein. Gaze tracking, proximity sensing, and the like may all be used to establish the relative position of a user with respect to the system, and thus to create and/or update the three-dimensional image seen by the user. This may equally apply to two-dimensional images and/or combinations of three-dimensional and two-dimensional images (e.g., combinatory images).

As one non-limiting example, a three-dimensional map of a city or other region may be generated. The system may track the relative orientation of the user with respect to the system. Thus, as the relative orientation changes, the portion, side or angle of the map seen by the user may change. Accordingly, as a user moves the system, different portions of the three-dimensional map may be seen.

This may permit a user to rotate the system or walk around the system and see different sides of buildings in the city, for example. As one non-limiting example, this may permit a map to update and change its three-dimensional display as a user holding the system changes his or her position or orientation, such that the map reflects what the user sees in front of him or her. The same functionality may be extended to substantially any application or visual display.

In another embodiment, the three-dimensional (and/or two-dimensional, and/or combinatory) image may be spatially invariant. In such embodiments, as a user moves or rotates the system, the same three-dimensional image may be shown in the same orientation relative to the user. Thus, even as the device is moved, the three-dimensional image displayed to the user may remain stationary.

By using internal sensors of the system/device, such as accelerometers, gyroscopes, magnetometers, and the like, the orientation of the system/device relative to the environment may be determined. Such data may be used to create and maintain a position-invariant three-dimensional, two-dimensional, and/or combinatory image.

It should be appreciated that various embodiments and functionalities described herein may be combined in a single embodiments. Further, embodiments and functionality described herein may be combined with additional input from a system/device, such as a camera input. This may permit the overlay of information or data on a video or captured image from a camera. The overlay may be two-dimensional, three-dimensional or combinatory, and may update with motion of the system/device, motion of the user, gaze of the user, and the like. This may permit certain embodiments to offer enhanced versions of augmented reality informational overlays, among other functionality.

FIG. 8 is a block diagram illustrating a system 800 for displaying a combined 2D and 3D image. The system may include a computing device 801, which may be the computing device 101 of FIG. 1.

The computing device 801 may include one or more processing units 802, one or more non-transitory storage media 803 (which may take the form of, but is not limited to, a magnetic storage medium; optical storage medium; magneto-optical storage medium; read only memory; random access memory; erasable programmable memory; flash memory; and so on), one or more displays 804, one or more image sensors 805, and/or one or more motion sensors 806.

The display 804 may be any kind of display such as a LCD, a plasma display, a cathode ray tube display, an LED (light emitting diode) display, an OLED (organic light emitting diode) display, and/or other such display. Further, the display may include an overlay layer such as the overlay layers described above and illustrated in FIGS. 2A-5C. The image sensor(s) 805 may be any kind of image sensor, such as one or more still cameras, one or more video cameras, and/or one or more other image sensors. The motion sensor(s) 806 may be any kind of motion sensor, such as one or more accelerometers, one or more gyroscopes, and/or one or more other motion sensors.

The processing unit 802 may execute instructions stored in the storage medium 803 in order to perform one or more computing device 801 functions. Such computing device 801 functions may include displaying one or more 2D images, 3D images, combination 2D and 3D images, multiple view images, determining computing device 801 orientation and/or changes, determining and/or estimating the position of one or more eyes of one or more users, continuing to display and/or altering display of one or more images based on changes in computing device 801 orientation and/or movement and/or changes in position of one or more eyes of one or more users, and/or any other such computing device 801 operations. Such computing device 801 functions may utilize one or more of the display(s) 804, the image sensor(s) 805, and/or the motion sensor(s) 806.

In some implementations, when the computing device 801 is displaying one or more 3D images and/or combinations of 2D and 3D images, the computing device 801 may alter the presentation of the 3D portions. Such alteration may include increasing and/or decreasing the apparent depth of the 3D portions, increasing or decreasing the amount of the portions presented in 3D, increasing or decreasing the number of objects presented in 3D in the 3D portions, and/or various other alterations. This alteration may be performed based on hardware and/or software performance measurements, in response to user input (such as a slider where a user can move an indicator to increase and/or decrease the apparent depth of 3D portions), user eye position and/or movement (for example, a portion may not be presented with as much apparent depth if the user is currently not looking at that portion), and/or in response to other factors (such as instructions issued by one or more executing programs and/or operating system routines).

In various implementations, as the various overlays described above can be utilized to configure presentation of images for a user, the overlay may be utilized to present an image based on a user's vision prescription (such as a 20/40 visual acuity, indicating that the user is nearsighted). In such cases, the user may have previously entered the user's particular vision prescription and the computing device 801 may adjust to display the image based on that particular prescription so that a vision impaired user may not require corrective lenses in order to view the image (such as adjusting the display for a user with 20/40 visual acuity to correct for the user's nearsighted condition without requiring the user to utilize corrective lenses to see the display correctly).

In one or more implementations, when combined 2D and 3D images are presented, the computing device 801 may combine the 2D and 3D portions such that the respective portions share a dimensional plane (such as the horizontal plane). In this way, a user may not be required to strain their eyes as much when looking between 2D and 3D portions, or when attempting to look simultaneously at 2D and 3D portions.

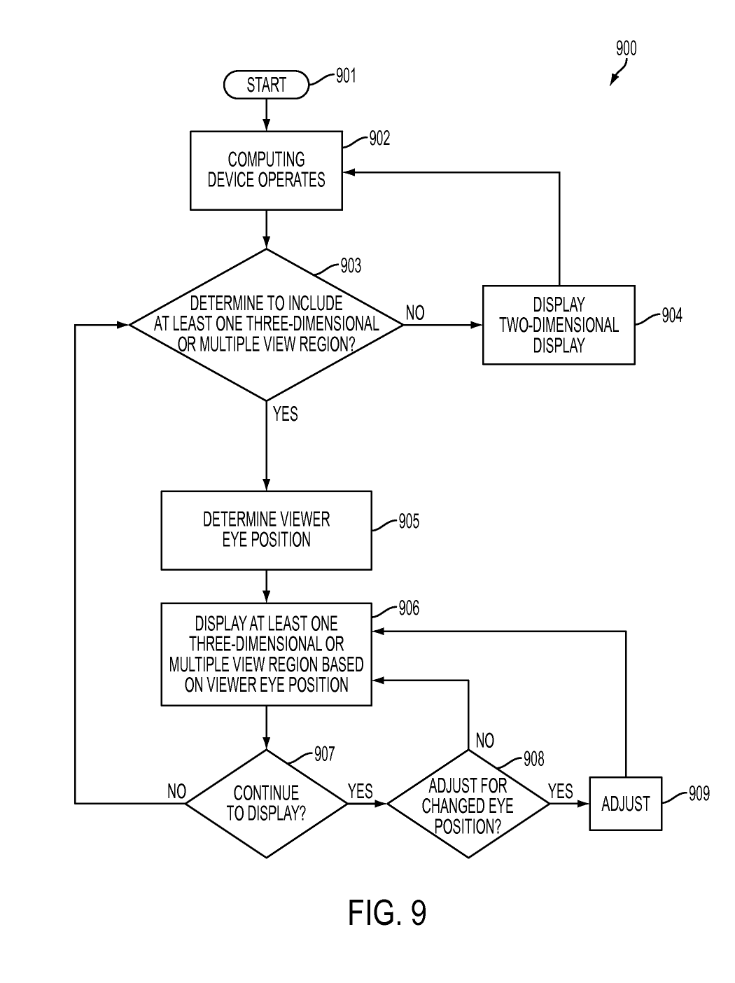

FIG. 9 illustrates an example method 900 for presenting 2D images, 3D images, combination 2D and 3D images, multiple view images, and/or combinations thereof. The method 900 may be performed by the electronic device 101 of FIG. 1. The flow begins at block 901 and proceeds to block 902 where a computing device operates.

The flow then proceeds to block 903 where the computing device determines whether or not to include at least one three-dimensional or multiple view regions in an image to display. If so, the flow proceeds to block 904. Otherwise, the flow proceeds to block 904 where the image is displayed as a 2D image before the flow returns to block 902 and the computing device continues to operate.

At block 905, after the computing device determines to include at least one three-dimensional or multiple view region in an image to display, the computing device determines the position of at least one eye of at least one user. In some cases, such determination may involve capturing one or more images of one or more users and/or one or more eyes of one or more users, estimating the position of a user's eyes based on data from one or more motion sensors and/or how the computing device is being utilized, and so on. The flow then proceeds to block 906 where the image is displayed with one or more 3D regions and/or one or more multiple view regions based on the determined viewer eye position.

The flow then proceeds to block 907. At block 907, the computing device determines whether or not to continue displaying an image with one or more 3D or multiple view regions. If not, the flow returns to block 903 where the computing device determines whether or not to include at least one 3D or multiple view region in an image to display. Otherwise, the flow proceeds to block 908.

At block 908, after the computing device determines to continue displaying an image with one or more 3D or multiple view regions, the computing device determines whether or not to adjust for changed eye position. Such a determination may be made based on a detected or estimated change in eye position, which may in turn be based on data from one or more image sensors and/or one or more motions sensors. If not, the flow returns to block 906 where an image is displayed with one or more 3D regions and/or one or more multiple view regions based on the determined viewer eye position. Otherwise, the flow proceeds to block 909.

At block 909, after the computing device determines to adjust for changed eye position, the computing device adjusts for changed eye position. The flow then returns to block 906 where an image is displayed with one or more 3D regions and/or one or more multiple view regions based on the changed viewer eye position.

Although the method 900 is illustrated and described above as including particular operations performed in a particular order, it is understood that this is for the purposes of example. In various implementations, other orders of the same and/or different operations may be performed without departing from the scope of the present disclosure. For example, in one or more implementations, the operations of determining viewer eye position and/or adjusting for changed eye position may be performed simultaneously with other operations instead of being performed in a linear sequence.

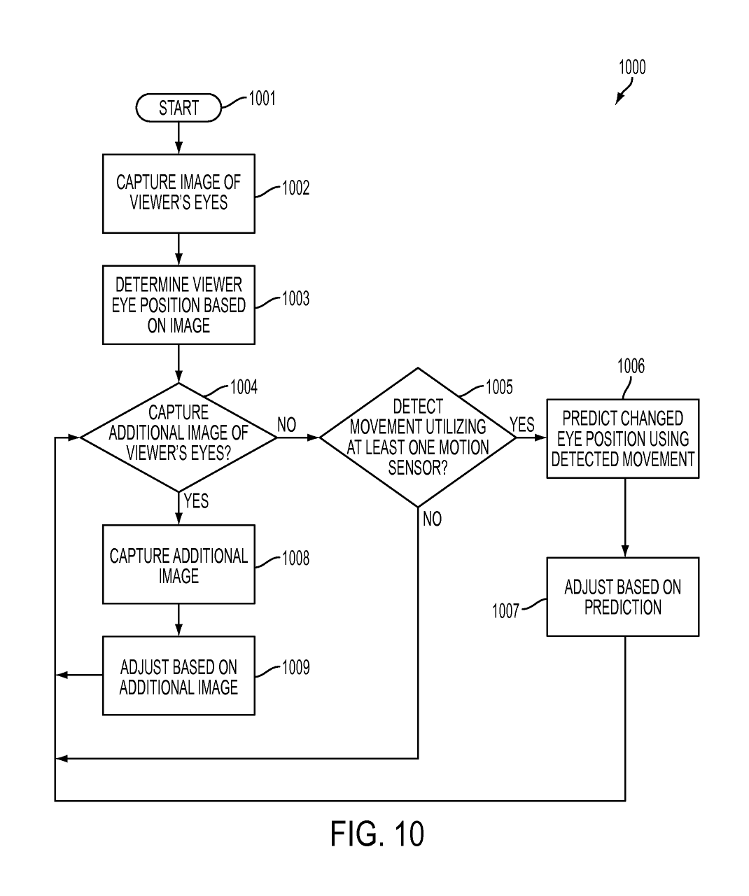

FIG. 10 illustrates an example method 1000 for determining a user's eye position. The method 1000 may be performed by the electronic device 101 of FIG. 1. The flow begins at block 201 and proceeds to block 1002 where an image is captured of a viewer's eyes. Such an image may be captured utilizing one or more image sensors. The flow then proceeds to block 1003 where the computing device determines the viewer's eye position based on the captured image.

The flow then proceeds to block 1004. At block 1004, the computing device determines whether or not to capture an additional image of the viewer's eyes. In some implementations, images of the viewer's eyes may only be captured periodically (such as once every 60 seconds). In such implementations, the determination of whether or not to capture an additional image of the viewer's eyes may depend on whether or not the period between captures has expired. If so, the flow proceeds to block 1008. Otherwise, the flow proceeds to block 1005.

At block 1008, after the computing device determines to capture an additional image of the viewer's eyes, the computing device captures the additional image. The flow then proceeds to block 1009 where the determination of the viewer's eye position is adjusted based on the additional captured image. Next, the flow returns to block 1004 where the computing device determines whether or not to capture an additional image of the viewer's eyes.

At block 1005, after the computing device determines not to capture an additional image of the viewer's eyes, the computing device determines whether or not movement of the computing device has been detected. Such movement may be detected utilizing one or more motion sensors (such as one or more accelerometers, one or more gyroscopes, and/or one or more other motion sensors). If not, the flow returns to block 1004 where the computing device determines whether or not to capture an additional image of the viewer's eyes. Otherwise, the flow proceeds to block 1006.

At block 1006, after the computing device determines that movement of the computing device has been detected, the computing device predicts a changed position of the viewer's eyes based on the detected movement and the previously determined viewer's eye position. The flow then proceeds to block 1007 where the determination of the viewer's eye position is adjusted based on the estimated viewer's eye position.

The flow then returns to block 1004 where the computing device determines whether or not to capture an additional image of the viewer's eyes.

Although the method 1000 is illustrated and described above as including particular operations performed in a particular order, it is understood that this is for the purposes of example. In various implementations, other orders of the same and/or different operations may be performed without departing from the scope of the present disclosure. For example, in one or more implementations, instead of utilizing motion sensors to estimate updated eye position between periods when an image of a user's eyes are captured, only captured user eye images or motion sensor data may be utilized to determine eye position. Alternatively, in other implementations, captured images of user eyes (such as gaze detection) and motion sensor data may be utilized at the same time to determine eye position.

Returning to FIG. 8, in various implementations the computing device 801 may be operable to capture one or more 3D images utilizing one or more image sensors 805. In a first example, the computing device 801 may capture two or more images of the same scene utilizing two or more differently positioned image sensors 805. These two or more images of the same scene captured utilizing the two or more differently positioned image sensors 805 may be combined by the computing device 801 into a stereoscopic image. Such a stereoscopic image may be of one or more users, one or more body parts of one or more users (such as hands, eyes, and so on), and/or any other object and/or objects in an environment around the computing device 801.

As such, the computing device 801 may be capable of receiving 3D input as well as being capable of providing 3D output. In some cases, the computing device 801 may interpret such a stereoscopic image (such as of a user and/or a user's body part), or other kind of captured 3D image, as user input. In one example, such a stereoscopic image as input may be interpreting a confused expression in a stereoscopic image of a user's face as a command to present a ‘help’ tool. In another example, 3D video captured of the movements of a user's hand while displaying a 3D object may be interpreted as instructions to manipulate the display of the 3D object (such as interpreting a user bringing two fingers closer together as an instruction to decrease the size of the displayed 3D object, interpreting a user moving two fingers further apart as an instruction to increase the size of the displayed 3D object, interpreting a circular motion of a user's finger as an instruction to rotate the 3D object, and so on).

By way of a second example, the computing device 801 may utilize one or more 3D image sensors 805 to capture an image of a scene as well as volumetric and/or other spatial information regarding that scene utilizing spatial phase imaging techniques. In this way, the computing device 801 may capture one or more 3D images utilizing as few as a single image sensor 805.

By way of a third example, the computing device 801 may utilize one or more time-of-flight image sensors 805 to capture an image of a scene as well as 3D information regarding that scene. The computing device 801 may capture 3D images in this way by utilizing time-of-flight imaging techniques, such as by measuring the time-of-flight of a light signal between the time-of-flight image sensor 805 and points of the scene.

By way of a fourth example, the computing device 801 may utilize one or more different kind of image sensors 805 to capture different types of images that the computing device 801 may combine into a 3D image.

In one such case, which is described in U.S. patent application Ser. no. 12/857,903, which is incorporated by reference in its entirety as if set forth directly herein, the computing device 801 may include a luminance image sensor for capturing a luminance image of a scene and a first and second chrominance image sensor for capturing first and second chrominance images of the scene. The computing device 801 may combining the captured luminance image of the scene and the first and second chrominance images of the scene to form a composite, 3D image of the scene.

In another example, the computing device 801 may utilize a single chrominance sensor and multiple luminance sensors to capture 3D images.

Although various examples have been described above how the computing device 801 may utilize one or more image sensors 805 to capture 3D images, it is understood that these are examples. In various implementations, the computing device 801 may utilize a variety of different techniques other than the examples mentioned for capturing 3D images without departing from the scope of the present disclosure.

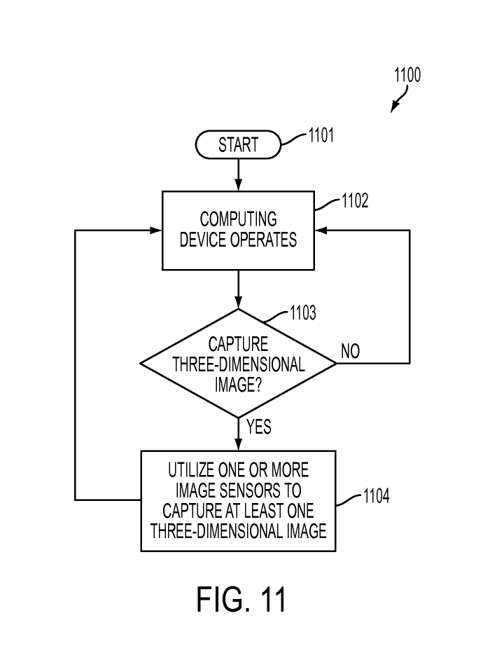

FIG. 11 illustrates an example method 1100 for capturing one or more 3D images. The method 1100 may be performed by the electronic device 101 of FIG. 1. The flow begins at block 1101 and proceeds to block 1102 where the computing device operates.

The flow then proceeds to block 1103 where the computing device determines whether or not to capture one or more 3D images. Such 3D images may be one or more 3D still images, one or more segments of 3D video, and/or other 3D images. If so, the flow proceeds to block 1104. Otherwise, the flow returns to block 1102 where the computing device continues to operate.

At block 1104, after the computing device determines to capture one or more 3D images, the computing device utilizes one or more image sensors (such as one or more still image cameras, video cameras, and/or other image sensors) to capture at least one 3D image. The flow then returns to block 1102 where the computing device continues to operate.

Although the method 1100 is illustrated and described above as including particular operations performed in a particular order, it is understood that this is for the purposes of example. In various implementations, other orders of the same and/or different operations may be performed without departing from the scope of the present disclosure. For example, in one or more implementations, other operations may be performed such as processing captured 3D images in order to interpret the captured 3D images as user input.

Generally, embodiments have been described herein with respect to a particular device that is operational to provide both two-dimensional and three-dimensional visual output, either sequentially or simultaneously. However, it should be appreciated that the output and devices described herein may be coupled with, or have incorporated therein, certain three-dimensional input capabilities as well.

For example, embodiments may incorporate one or more position sensors, one or more spatial sensors, one or more touch sensors, and the like. For purposes of this document, a “position sensor” may be any type of sensor that senses the position of a user input in three-dimensional space. Examples of position sensors include cameras, capacitive sensors capable of detecting near-touch events (and, optionally, determining approximate distances at which such events occur), infrared distance sensors, ultrasonic distance sensors, and the like.

Further, “spatial sensors” are generally defined as sensors that may determine, or provide data related to, a position or orientation of an embodiment (e.g., an electronic device) in three-dimensional space, including data used in dead reckoning or other methods of determining an embodiment's position. The position and/or orientation may be relative with respect to a user, an external object (for example, a floor or surface, including a supporting surface), or a force such as gravity. Examples of spatial sensors include accelerometers, gyroscopes, magnetometers, and the like. Generally sensors capable of detecting motion, velocity, and/or acceleration may be considered spatial sensors. Thus, a camera (or another image sensor) may also be a spatial sensor in certain embodiments, as successively captured images may be used to determine motion and/or velocity and acceleration.

“Touch sensors” generally include any sensor capable of measuring or detecting a user's touch. Examples include capacitive, resistive, thermal, and ultrasonic touch sensors, among others. As previously mentioned, touch sensors may also be position sensors, to the extent that certain touch sensors may detect near-touch events and distinguish an approximate distance at which a near-touch event occurs.

Given the foregoing sensors and their capabilities, it should be appreciated that embodiments may determine, capture, or otherwise sense three-dimensional spatial information with respect to a user and/or an environment. For example, three-dimensional gestures performed by a user may be used for various types of input. Likewise, output from the device (whether two-dimensional or three-dimensional) may be altered to accommodate certain aspects or parameters of an environment or the electronic device itself.

Generally, three-dimensional output may be facilitated or enhanced through detection and processing of three-dimensional inputs. Appropriately configured sensors may detect and process gestures in three-dimensional space as inputs to the embodiment. As one example, a sensor such as an image sensor may detect a user's hand and more particularly the ends of a user's fingers. Such operations may be performed by a processor in conjunction with a sensor, in many embodiments; although the sensor may be discussed herein as performing the operations, it should be appreciated that such references are intended to encompass the combination of a sensor(s) and processor(s).

Once a user's fingers are detected, they may be tracked in order to permit the embodiment to interpret a three-dimensional gesture as an input. For example, the position of a user's finger may be used as a pointer to a part of a three-dimensional image displayed by an embodiment. As the user's finger draws nearer to a surface of the electronic device, the device may interpret such motion as an instruction to change the depth plane of a three-dimensional image simulated by the device. Likewise, moving a finger away from the device surface may be interpreted as a change of a depth plane in an opposite direction. In this manner, a user may vary the height or distance from which a simulated three-dimensional image is shown, effectively creating a simulated three-dimensional zoom effect. Likewise, waiving a hand or a finger may be interpreted as a request to scroll a screen or application. Accordingly, it should be appreciated that motion of a hand or finger in three-dimensional may be detected and used as an input, in addition to or instead of depth or distance from the device to the user's member.

As another example of an input gesture that may be recognized by an embodiment, squeezing or touching a finger and a thumb together by a user may be interpreted by an embodiment as the equivalent of clicking a mouse button. As the finger and thumb are held together, the embodiment may equate this to holding down a mouse button. If the user moves his or her hand while holding finger and thumb together, the embodiment may interpret this as a “click and drag” input. However, since the sensor(s) may track the user's hand in three-dimensional space, the embodiment may permit clicking and dragging in three dimensions, as well. Thus, as a user's hand moves in the Z-axis, the information displayed by the embodiment may likewise move along a simulated Z-axis. Continuing the example, moving the thumb and finger away from each other may be processed as an input analogous to releasing a mouse button.

It should be appreciated that rotation, linear motion, and combinations thereof may all be tracked and interpreted as inputs by embodiments disclosed herein. Accordingly, it should be appreciated that any variety of gestures may be received and processed by embodiments, and that the particular gestures disclosed herein are but examples of possible inputs. Further, the exact input to which any gesture corresponds may vary between embodiments, and so the foregoing discussion should be considered examples of possible gestures and corresponding inputs, rather than limitations or requirements. Gestures may be used to resize, reposition, rotate, change perspective of, and otherwise manipulate the display (whether two-dimensional, three-dimensional, or combinatory) of the device.

Insofar as an electronic device may determine spatial data with respect to an environment, two- and three-dimensional data displayed by a device may be manipulated and/or adjusted to account for such spatial data. As one example, a camera capable of sensing depth, at least to some extent, may be combined with the three-dimensional display characteristics described herein to provide three-dimensional or simulated three-dimensional video conferencing. One example of a suitable camera for such an application is one that receives an image formed from polarized light in addition to (or in lieu of) a normally-captured image, as polarized light may be used to reconstruct the contours and depth of an object from which it is reflected.

Further, image stabilization techniques may be employed to enhance three-dimensional displays by an embodiment. For example, as a device is moved and that motion is sensed by the device, the three-dimensional display may be modified to appear to be held steady rather than moving with the device. This may likewise apply as the device is rotated or translated. Thus, motion-invariant data may be displayed by the device.

Alternatively, the simulated three-dimensional display may move (or appear to move) as an embodiment moves. Thus, if the user tilts or turns the electronic device, the sensed motion may be processed as an input to similarly tilt or turn the simulated three-dimensional graphic. In such embodiments, the display may be dynamically adjusted in response to motion of the electronic device. This may permit a user to uniquely interact with two-dimensional or three-dimensional data displayed by the electronic device and manipulate such data by manipulating the device itself.

As illustrated and described above, the present disclosure discloses systems and methods for displaying a combined 2D and 3D image. A computing device may include a display with an overlay layer that enables the display to present 2D images, 3D images, a simultaneous combination of 2D and 3D images, and/or multiple view images (i.e., different users see different images when looking at the same screen). In some implementations, the overlay layer may be one or more liquid crystal display (LCD) matrix pixel masks, a number of lenses, one or more LCD layers configurable as lenses, or various combinations thereof. In various implementations, the overlay layer may be adjusted to continue display (or alter display) of 3D portions and/or multiple view portions when the orientation of the computing device is changed.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A system for displaying a combined two-dimensional and three-dimensional image, comprising:
at least one processing unit;
at least one storage medium;
at least one display; and
at least one mode layer positioned on the at least one display;
wherein the at least one processing unit executes instructions stored in the at least one storage medium to:
display at least one image on the at least one display; and
control the at least one mode layer to simultaneously present at least a first portion of the at least one image to at least one user as a two-dimensional image and at least a second portion of the at least one image to the at least one user as a three-dimensional image.

2. The system of claim 1, wherein the at least one processing unit executes instructions stored in the at least one storage medium to control the at least one mode layer to present a first version of at least one region of the at least one image or at least one additional image to the at least one user and a second version of the at least one region of the at least one image or at least one additional image to at least an additional user.

3. The system of claim 1, wherein the at least one processing unit executes instructions stored in the at least one storage medium to control the at least one mode layer to present the entire at least one image in at least one of two dimensions or three dimensions.

4. The system of claim 1, further comprising at least one image sensor wherein the at least one processing unit executes instructions stored in the at least one storage medium to determine a position of at least one eye of the at least one user based on at least one image captured utilizing the at least one image sensor and controls the at least one mode layer to present the second portion of the at least one image to the at least one user as the three-dimensional image based at least on the determined eye position.

5. The system of claim 4, further comprising at least one motion sensor wherein the at least one processing unit executes instructions stored in the at least one storage medium to estimate a change to the determined eye position utilizing the at least one motion sensor and controls the at least one mode layer to update presentation of the second portion of the at least one image to the at least one user as the three-dimensional image based at least on the estimated changed eye position.

6. The system of claim 5, wherein the at least one motion sensor comprises at least one of at least one accelerometer or at least one gyroscope.

7. The system of claim 4, wherein the at least one processing unit executes instructions stored in the at least one storage medium to determine a changed position of the at least one eye of the at least one user based on at least one additional image captured utilizing the at least one image sensor and controls the at least one mode layer to update presentation of the second portion of the at least one image to the at least one user as the three-dimensional image based at least on the determined changed eye position.

8. The system of claim 1, wherein the at least one mode layer comprises at least one liquid crystal display matrix mask layer.

9. The system of claim 8, wherein the at least one liquid crystal display matrix mask layer includes a matrix of liquid crystal elements that each block one of a plurality of pixels of the at least one display when activated by the at least one processing unit.

10. The system of claim 1, wherein the at least one mode layer comprises at least one liquid crystal display layer wherein the at least one processing unit manipulates an electrical field at a portion of the at least one liquid crystal display layer to increase a density of liquid crystals at the portion.

11. The system of claim 10, wherein increasing the density of the liquid crystals at the portion alters a refractive index of the portion to alter how light passes through the at least one liquid crystal display layer at the portion.

12. The system of claim 10, wherein the at least one mode layer further comprises a plurality of circular lenses positioned on the at least one liquid crystal display layer.

13. The system of claim 1, wherein the at least one mode layer comprises a plurality of circular lenses wherein the at least one processing unit manipulates an electrical field at a portion of at least one of the plurality of circular lenses to increase a density of liquid crystals at the portion.

14. The system of claim 13, wherein increasing the density of the liquid crystals at the portion alters a refractive index of the portion to alter how light passes through the at least one of the plurality of circular lenses.

15. The system of claim 1, further comprising at least one motion sensor wherein the at least one processing unit executes instructions stored in the at least one storage medium to:
determine that an orientation of the at least one display has changed utilizing the at least one motion sensor; and
control the at least one mode layer to present the second portion of the at least one image to the at least one user as a three-dimensional image at the changed orientation.

16. The system of claim 1, further comprising at least one motion sensor wherein the at least one processing unit executes instructions stored in the at least one storage medium to:
determine that an orientation of the at least one display has changed utilizing the at least one motion sensor; and
present a different three-dimensional orientation of the second portion of the at least one image to the at least one user based at least on the changed orientation.

17. The system of claim 1, wherein the at least one processing unit executes instructions stored in the at least one storage medium to control the at least one mode layer to alter a three-dimensional depth of the second portion of the at least one image.

18. The system of claim 17, wherein the at least one processing unit controls the at least one mode layer to alter the three-dimensional depth of the second portion of the at least one image based at least on at least one of a received user input or detected user eye position.

19. The system of claim 1, wherein the at least one processing unit executes instructions stored in the at least one storage medium to control the at least one mode layer to alter a number of objects presented in three-dimensions in the second portion of the at least one image.

20. The system of claim 19, wherein the at least one processing unit controls the at least one mode layer to alter number of objects presented in three-dimensions in the second portion of the at least one image based at least on at least one of a received user input or detected user eye position.

21. The system of claim 1, further comprising at least one image sensor wherein the at least one processing unit executes instructions stored in the at least one storage medium to capture at least one three dimensional image utilizing the at least one image sensor.

22. The system of claim 1, wherein at least one processing unit executes instructions stored in the at least one storage medium to control the at least one mode layer to configure the second portion of the at least one image to share a dimensional plane with the first portion of the at least one image.

23. The system of claim 1, wherein the at least one processing unit executes instructions stored in the at least one storage medium to control the at least one mode layer to alter the amount of the at least one image presented in three-dimensions.

24. The system of claim 23, wherein the at least one processing unit alters the amount of the at least one image presented in three-dimensions based at least on at least one of a received user input or detected user eye position.

25. The system of claim 1, wherein the at least one processing unit executes instructions stored in the at least one storage medium to control the at least one mode layer to present at least one of the at least one image or at least one additional image based on a vision rating of the at least one user.

26. The system of claim 1, wherein the at least one display and the at least one mode layer are incorporated into a handheld computing device.

27. A method for displaying a combined two-dimensional and three-dimensional image, the method comprising:
displaying, utilizing at least one processing unit, at least one image on at least one display; and
controlling, utilizing the at least one processing unit, at least one mode layer positioned on the at least one display to simultaneously present at least a first portion of the at least one image to at least one user as a two-dimensional image and at least a second portion of the at least one image to the at least one user as a three-dimensional image.

28. The method of claim 27, further comprising:
detecting a gesture in three-dimensional space; and
modifying an output of the at least one image in response to the gesture.
